(19) United States
(12) Patent Application Publication
(10) Pub. No.: US 2012/0226423 A1
(43) Pub. Date: Sep. 6, 2012

(54) VEHICLE DRIVING SUPPORT APPARATUS

(75) Inventor: Hiroyuki SEKIGUCHI, Tokyo (JP)

(73) Assignee: Fuji Jukogyo Kabushiki Kaisha, Tokyo (JP)

(21) Appl. No.: 13/411,419

(22) Filed: Mar. 2, 2012

(30) Foreign Application Priority Data
Mar. 3, 2011 (JP) 2011-046746

(51) Int. Cl. B60T 7/12

(52) U.S. Cl. 701/70

(57) ABSTRACT

In a vehicle driving support apparatus, a cruise control unit determines a possibility of a collision of a subject vehicle 1 and an obstacle. If it is determined that there is a high possibility of a collision of the subject vehicle and the obstacle, the cruise control unit previously sets a braking force for preventing a collision against the obstacle and outputs a signal regarding the set braking force to an automatic braking control to generate deceleration. If a steering operation by a driver is detected at this time, the braking force to be generated is adjusted to a lower value.

### CROSS REFERENCES TO RELATED APPLICATIONS

The present application claims priority from Japanese Patent Application No. 2011-046746 filed on Mar. 3, 2011, the entire contents of which are hereby incorporated by reference.

### BACKGROUND OF THE INVENTION

1. Field of the Invention

The present invention relates to vehicle driving support apparatuses for preventing a collision by performing braking control through an automatic braking intervention, independently from a brake operation by a driver, when there is a high possibility that a subject vehicle can collide with a control object such as a preceding vehicle.

2. Description of the Related Art

In recent years, various automatic braking control apparatuses have been proposed and in practical use for preventing a collision by performing automatic braking control, independently from a brake operation by a driver, when there is a high possibility that a subject vehicle can collide with an obstacle such as a vehicle. For example, Japanese Unexamined Patent Application Publication (JP-A) No. H8-91190 discloses a technology for a vehicle collision prevention device that calculates a minimum vehicle braking force required to avert a collision based on a relative speed and distance with respect to a preceding vehicle and a vehicle braking force applied by the driver, compares the two vehicle braking forces, and performs automatic braking control based on the value of a larger one therebetween.

In addition to deceleration by a braking force, avoidance turning is often performed in which a driver turn a steering wheel to avoid a collision against an obstacle. If the driver turns the steering wheel during the execution of a collision prevention operation against an obstacle with a maximum braking force according to the technology disclosed in JP-A No. H8-91190, a sufficient cornering force cannot be generated on tires, whose gripping force is mostly used for braking, whereby it is difficult to avoid the obstacle with sufficient turning that the driver desires.

### SUMMARY OF THE INVENTION

The present invention is made in view of the above, and it is an object of the present invention to provide a vehicle driving support apparatus that accurately and reliably performs obstacle prevention by braking only as well as performs highly reliable collision prevention control using a sufficient turning motion that a driver desires when the driver performs avoidance turning by a steering operation in addition to braking.

An aspect of the present invention provides a vehicle driving support apparatus that includes: a front obstacle information detecting unit for detecting information on a front obstacle; a collision possibility determining unit for determining a possibility of a collision of a subject vehicle and the front obstacle; a collision prevention control unit for setting previously and generating a braking force for preventing a collision against the front obstacle; and a braking force adjusting unit for adjusting the braking force to be generated by the collision prevention control unit to a lower value when a steering operation by a driver is detected.

### BRIEF DESCRIPTION OF THE DRAWINGS

FIG. 1 is a schematic configuration view of a vehicle driving support apparatus according to an embodiment of the present invention;

FIG. 2 is a flowchart of a collision prevention control program in the vehicle driving support apparatus according to the embodiment of the present invention; and

FIG. 3 is a characteristic map of an initially applied driving force FB0 that is set based on a road friction coefficient μ according to the embodiment of the present invention.

### DESCRIPTION OF THE PREFERRED EMBODIMENTS

An embodiment of the present invention will hereunder be described with reference to the drawings.

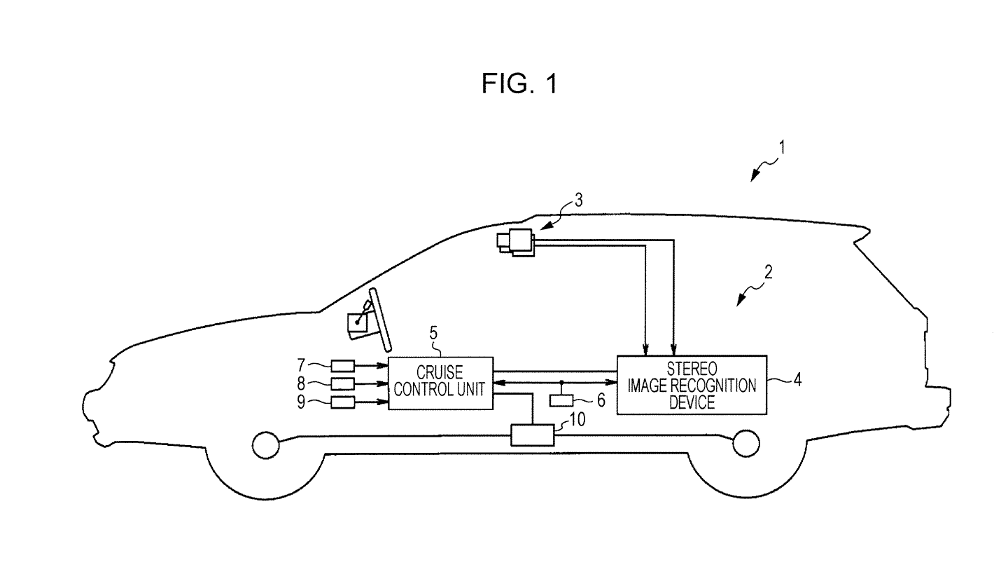

In FIG. 1, reference numeral 1 denotes a vehicle (subject vehicle) such as an automobile. The vehicle 1 includes a vehicle driving support apparatus 2 that has a collision prevention function for preventing a collision by performing braking control through an automatic braking intervention, independently from a brake operation by a driver, when there is a high possibility of a collision with a control object such as an obstacle and a preceding vehicle.

The vehicle driving support apparatus 2 mainly includes a stereo camera 3, a stereo image recognition device 4, and a cruise control unit 5.

The stereo camera 3 is constituted by a left and right pair of CCD cameras using solid state imaging devices such as charge-coupled devices (CODs), for example. The CCD cameras in the pair are attached on front portions of a ceiling of a passenger compartment with a predetermined distance therebetween, capture images of an external object in stereo from different points of view, and output captured image information to the stereo image recognition device 4.

In addition to the image information from the stereo camera 3, the stereo image recognition device 4 receives a subject vehicle speed V and the like from a vehicle speed sensor 6. The stereo image recognition device 4 recognizes front information such as three-dimensional object data and lane line data in front of the subject vehicle 1 based on the image information from stereo camera 3, and estimates a traveling route of the subject vehicle based on the recognition information. Furthermore, the stereo image recognition device 4 examines whether or not any three-dimensional object such as an obstacle and a preceding vehicle is present on the traveling route of the subject vehicle. If a three-dimensional object is present, the stereo image recognition device 4 recognizes a closest object as a control object for braking control.

The stereo image recognition device 4 processes the image information from the stereo camera 3 in the following manner, for example. Firstly, distance information is generated for a pair of stereo images in the traveling direction of the subject vehicle 1 captured by the stereo camera 3, based on an amount of misalignment between corresponding positions in the images according to the principle of triangulation. Then, the image information is subjected to a known grouping process, and the processed information is compared with three-dimensional road shape data, three-dimensional object data and the like that are previously stored. As a result of the comparison, lane line data, side wall data on a guardrail and a curb extending along the road, and three-dimensional data on a vehicle and the like are extracted. Furthermore, the stereo image recognition device 4 estimates the traveling route of the subject vehicle 1 based on the lane line data, the side wall data and the like, and extracts (detects) an object that is present in the front of and the most nearest to the subject vehicle 1 in the traveling route, as a control object for braking control. If an obstacle is detected, the stereo image recognition device 4 calculates information on the obstacle such as a relative distance d between the subject vehicle 1 and the obstacle, a traveling speed Vf of the obstacle (=(a rate of change in the relative distance d)+(the subject vehicle speed V)), a deceleration at of the control object (a differential value of the traveling speed Vf of the control object) and a lapping rate Rr between the subject vehicle 1 and the obstacle in the width direction (a rate of an amount in the width of the subject vehicle 1 overlapping the width of the obstacle with respect to the width of the subject vehicle 1). In this manner, the stereo image recognition device 4 implements functions of a front obstacle information detecting unit of the present invention, together with the stereo camera 3.

The cruise control unit 5 receives various kinds of information on the control object recognized by the stereo image recognition device 4. Furthermore, the cruise control unit 5 receives a subject vehicle speed V detected by the vehicle speed sensor 6, a steering wheel angle θH from a steering wheel angle sensor 7, a road friction coefficient μ estimated by a road friction coefficient estimator 8, and a signal regarding an ON/OFF operation of a brake pedal from a brake pedal switch 9. The road friction coefficient estimator 8 may use any one of an estimation method of the road friction coefficient μ based on an adaptive control theory disclosed in JP-A. No. H8-2274 by the applicant of the present invention, an estimation method of the road friction coefficient μ using an observer disclosed in, for example, JPA-2000-71968 by the applicant of the present invention, and an estimation method of the road friction coefficient μ based on a state of a traveling road (dry road, wet road or snowy road, for example) recognized by the stereo image recognition device 4 from a captured image.

Based on the above input signals, the cruise control unit 5 examines a possibility of a collision between the subject vehicle 1 and the obstacle. When it is determined that there is a high possibility of a collision between the subject vehicle 1 and the obstacle, the cruise control unit 5 previously sets a braking force for preventing a collision against the obstacle and outputs an signal regarding the set braking force to an automatic braking controller 10 to generate deceleration. If a steering operation by the driver is detected at this time, the cruise control unit 5 adjusts the braking force to be generated to a lower value. If the lapping rate Rr between the subject vehicle 1 and the obstacle exceeds a predetermined threshold Rrc (for example, 50%), the adjustment of the braking force upon the detection of a steering operation by the driver is prohibited.

In the present embodiment, the cruise control unit 5 examines a possibility of a collision between the subject vehicle 1 and an obstacle by, for example, comparing a time to collision (TTC) and a predetermined threshold Tc. The TTC is an expected time that will elapse until the subject vehicle 1 collides with the obstacle, and is obtained by dividing the relative distance d between the subject vehicle 1 and the obstacle by a relative speed therebetween. When the time to collision TTC is shorter than the predetermined threshold Tc, it is determined that there is a high possibility of a collision between the subject vehicle 1 and the obstacle. In this manner, the cruise control 5 implements functions of a collision possibility determining unit, a collision prevention control unit and a braking force adjusting unit of the present invention.

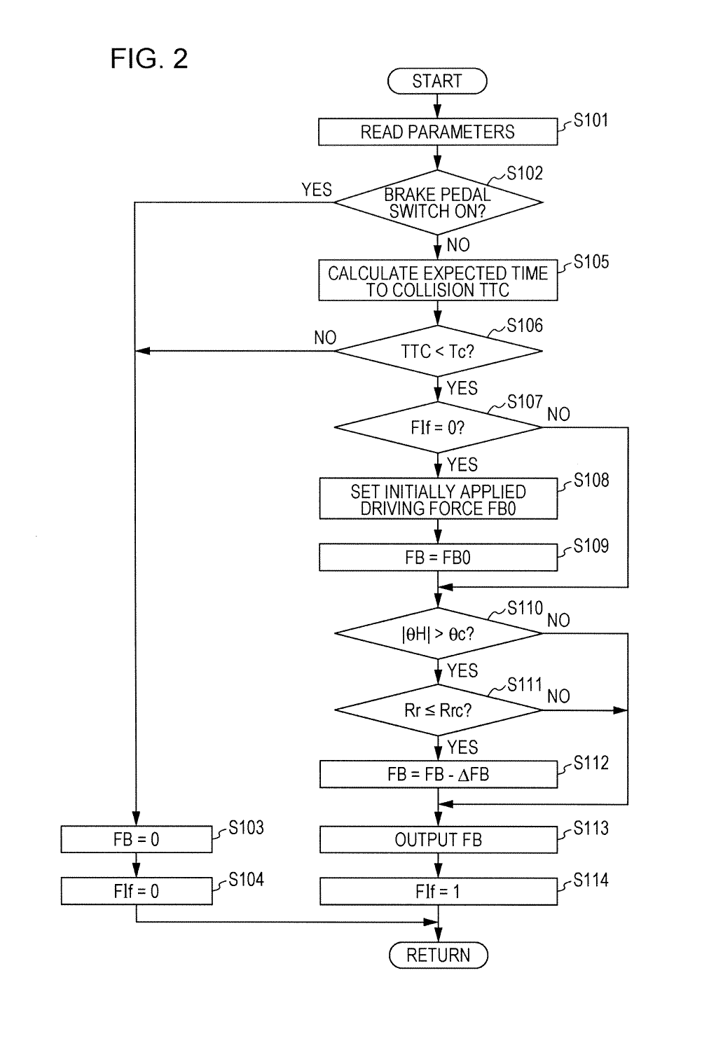

Next, the above-described collision prevention control executed by the cruise control unit 5 will be explained with reference to a flowchart shown in FIG. 2.

Firstly, in step (hereinafter abbreviated as “S”) 101, necessary parameters are read including the subject vehicle speed V, the steering wheel angle θH, the road friction coefficient μ, the signal regarding an ON/OFF operation of the brake pedal as well as obstacle information such as the relative distance d between the subject vehicle and the obstacle, the traveling speed Vf of the obstacle, the deceleration af of the obstacle, and the lapping rate Rr between the subject vehicle 1 and the obstacle.

Then the program proceeds to S102 where it is determined whether or not the brake pedal switch 9 is turn on. If the brake pedal switch 9 is turned on, which indicates that the driver is already performing collision prevention by braking, and the program proceeds to S103. In S103, the cruise control unit 5 sets a braking force FB to be generated for preventing a collision against the obstacle to 0 (FB=0). Then the program proceeds to S104 where the cruise control unit 5 clears an automatic braking generation flag Flf (Flf=0). Then the program is exited. Note that the automatic braking generation flag Flf is set (Flf=1) when the cruise control unit 5 outputs a signal regarding the FB for preventing a collision against the obstacle to the automatic braking controller 10.

If it is determined in S102 that the brake pedal switch 9 is turned off, on the other hand, the program proceeds to the S105 where the time to collision TTC is calculated.

Then the time to collision TCC is compared with the predetermined threshold Tc. If the time to collision TTC is equal to or longer than the threshold Tc (TTC Tc), it is determined that the possibility of a collision between the obstacle and the subject vehicle 1 is low, and the program proceeds to S103. In S103, the cruise control unit 5 sets the braking force FB to be generated for preventing a collision against the obstacle to 0 (FB=0). Then the program proceeds to S102 where the automatic braking generation flag Flf is cleared (Flf=0). Then the program is exited.

If the time to collision TTC is shorter than the threshold Tc (TTC<Tc), it is determined that there is a high possibility of a collision between the obstacle and the subject vehicle 1, and the program proceeds to S107 where it is determined whether or not the automatic braking generation flag Flf is cleared (Flf=0).

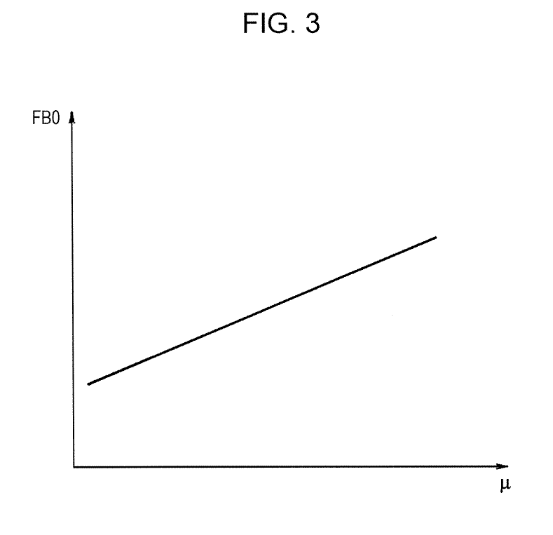

If Flf=0 in S107, it is determined that the current state is an initial state where the cruise control unit 5 begins to set the braking force FB for preventing a collision against obstacle. Then the program proceeds to S108 where an initially applied driving force FB0 corresponding to the road state (road friction coefficient μ) with reference to an characteristic map of an initially applied driving force as exemplified in FIG. 3. Then the program proceeds to S109 where the cruise control unit 5 sets the braking force FB to the thus-set initially applied driving force FB0, and then to S110.

As shown in FIG. 3, the initially applied driving force FB0 is set to a larger value as the road friction coefficient μ is larger. This is due to the fact that a road with a larger road friction coefficient μ generates a larger friction circle of a tire and a larger maximum gripping force thereof. The present embodiment considers this: upon collision prevention by generating a driving force, deceleration is performed with a braking force close to a maximum gripping force corresponding to the road state, the maximum gripping force being previously set based on an experiment, a simulation ad the like. Thus, the present embodiment can perform highly accurate, stable and reliable control. The initially applied driving force FB0 may be set by learning. Specifically, it may be obtained and stored by analyzing data upon traveling such as activation timing of an Anti-lock Brake System.

If Flf=1 in S107, that is, if the cruise control unit 5 has already generated the braking force FB for preventing a collision against the obstacle, the program skips to S105 without any change.

When the program proceeds to S110 from S109 or S107, it is determined whether or not the driver has turned the steering wheel, that is, whether or not an absolute value |θH| of the steering wheel angle exceeds a predetermined threshold θc that is a small positive angle value (|θH|>θc). If |θHθ>θc, that is, if it is determined that the driver has turned the steering wheel, the program proceeds to S111.

In S111, the lapping rate Rr between the subject vehicle 1 and the obstacle is compared with the predetermined threshold Rrc (for example, 50%). If the lapping rate Rr is smaller than or equal to the threshold Rrc (Rr Rrc), it is determined that the possibility of a collision between the obstacle and the subject vehicle 1 is low. Then the program proceeds to S112 where the currently-set braking force FB for preventing a collision against the obstacle is adjusted to a lower value (FB=FB−ΔFB, where ΔFB is a predetermined value).

Then, the program proceeds to S113 where the cruise control unit 5 outputs the signal regarding the newly-set braking force FB for preventing a collision against the obstacle to the automatic braking controller 10 so as to generate deceleration. Next, in S114, the automatic braking generation flag Flf is set (Flf=1). Then the program is exited.

If in S110 the absolute value |θH| of the steering wheel angle is smaller than or equal to the predetermined threshold θc (|θH|≦θc), which indicates the driver does not turn the steering wheel, or if in S111 the lapping rate Rr between the subject vehicle 1 and the obstacle exceeds the predetermined threshold Rrc (Rr>Rrc), which indicates there is a high possibility of a collision between the obstacle and the subject vehicle 1, the adjustment of the braking force FB for preventing a collision against the obstacle of S112 is not performed. Instead, the program proceeds to S113 where the cruise control unit 5 outputs the signal regarding the newly-set braking force FB for preventing a collision against the obstacle to the automatic braking controller 10 so as to generate deceleration, and then to S114 where the automatic braking generation flag Flf is set (Flf=1). Then the program is exited.

As described above, according to the present embodiment, the cruise control unit 5 determines the possibility of a collision of the subject vehicle 1 and an obstacle. If it is determined there is a high possibility of a collision of the subject vehicle 1 and the obstacle, the cruise control unit 5 previously sets a braking force FB to for preventing a collision against the obstacle and outputs a signal to the automatic braking controller 10 to generate deceleration. If it is detected that the driver has turned the steering wheel at this time, the braking force FB to be generated is adjusted to a lower value. Thus, even if the driver turns the steering wheel to prevent a collision against the obstacle upon collision prevention, a sufficient cornering force can be generated on tires, whereby it is possible to avoid the obstacle with a sufficient turning motion that the driver desires. Further, in the case where the driver does not turn the steering wheel or there is a high possibility of a collision between the subject vehicle and the obstacle, the braking force FB for preventing a collision against the obstacle is not adjusted to a lower value, whereby full collision prevention by braking is achieved using the braking force FB set by the cruise control unit 5. Furthermore, the road state (road friction coefficient μ) being taken into account and thus the braking force FB is set by the cruise control unit 5 closely to a maximum gripping force, whereby reliable collision prevention by braking is achieved. Thus, the present embodiment can accurately and reliably perform obstacle prevention by braking only as well as perform highly reliable collision prevention control using a sufficient turning motion that a driver desires when the driver performs avoidance turning by the steering operation in addition to braking.

While the present embodiment recognizes environment in front of the subject vehicle 1 based on image information from the stereo camera 3, the present invention is also applicable to a vehicle driving support apparatus that recognizes environment in front of a subject vehicle based on image information from a monocular camera.

What is claimed is:

1. A vehicle driving support apparatus comprising:
a front obstacle information detecting unit for detecting information on a front obstacle;
a collision possibility determining unit for determining a possibility of a collision of a subject vehicle and the front obstacle;
a collision prevention control unit for setting previously and generating a braking force for preventing a collision against the front obstacle; and
a braking force adjusting unit for adjusting the braking force to be generated by the collision prevention control unit to a lower value when a steering operation by a driver is detected.

2. The vehicle driving support apparatus according to claim 1, wherein the braking force adjusting unit prohibits adjusting the braking force to a lower value if the possibility of a collision against the front obstacle is higher than a predetermined level.

3. The vehicle driving support apparatus according to claim 2, wherein the collision possibility determining unit determines that the possibility of a collision against the front obstacle is higher than the predetermined level when a lapping rate between the subject vehicle and the front obstacle exceeds a predetermined threshold.

4. The vehicle driving support apparatus according to claim 1, wherein the braking force for preventing a collision against the front obstacle is variably set by the collision prevention control unit based on traveling environment of the subject vehicle.

5. The vehicle driving support apparatus according to claim 2, wherein the braking force for preventing a collision against the front obstacle is variably set by the collision prevention control unit based on traveling environment of the subject vehicle.

6. The vehicle driving support apparatus according to claim 3, wherein the braking force for preventing a collision against the front obstacle is variably set by the collision prevention control unit based on traveling environment of the subject vehicle.

7. The vehicle driving support apparatus according to claim 4, wherein the braking force for preventing a collision against the front obstacle is set higher by the collision prevention control unit when the subject vehicle is travelling on a road with a higher road friction coefficient.

8. The vehicle driving support apparatus according to claim 5, wherein the braking force for preventing a collision against the front obstacle is set higher by the collision prevention control unit when the subject vehicle is travelling on a road with a higher road friction coefficient.

9. The vehicle driving support apparatus according to claim 6, wherein the braking force for preventing a collision against the front obstacle is set higher by the collision prevention control unit when the subject vehicle is travelling on a road with a higher road friction coefficient.
